(19) United States
(12) Patent Application Publication
(10) Pub. No.: US 2005/0079262 A1
(43) Pub. Date: Apr. 14, 2005

(54) Tongue-shaped dispenser for dissolvable film strips

(76) Inventor: Brent Jay Oeschger, Malibu, CA (US)

Correspondence Address: LAW OFFICE OF RICHARD B. KLAR, 28 East Old Country Road, Hicksville, NY, 11801, US

(21) Appl. No.: 10/682,457

(22) Filed: Oct. 9, 2003

(51) Int. Cl. B65D 73/00; A23P 1/00

(52) U.S. Cl. 426/516; 426/660

(57) ABSTRACT

A decorative dispenser for dispensing film strips is provided which includes a dispenser having a top surface. The top surface has an opening therein for allowing access to the film strips housed within the dispenser. The decorative dispenser further includes a flip top lid having one end pivotally attached to the top surface of the dispenser and an another end adapted to engage a front portion of said dispenser to sealing close the opening in said top surface of said dispenser, said flip top lid being configured to resemble a tongue. Further, a character, person's, or animal's face (e.g. image of eyes, nose and open mouth) is preferably affixed or placed onto the top surface of the dispenser above the tongue shaped flip top lid to give the appearance as if the tongue lid is part of the above-mentioned face and to give the dispenser an overall decorative effect pleasing to children.

### CROSS REFERENCES TO RELATED APPLICATIONS

The application is related to co-pending design patent application Serial No. 29/185,354 filed on Jun. 25, 2003.

### BACKGROUND OF THE INVENTION

1. Field of the Invention

The present invention relates to dispensers. In particular, the present invention relates to decorative pocket size dispensers for dispensing orally dissolvable film strips, such as candy flavored film strips.

2. The Prior Art

Dispensers are known in the prior art. For instance, U.S. Pat. No. 3,421,658 provides in relevant part a dispenser for cards, razor blades, and other similar flat objects. The dispenser may take the form of a flat rectangular object, which forms a tray like compartment having a flat bottom. The dispenser may be made of a one-piece plastic material, and it can be used for dispensing flat objects of a variety of thicknesses. The dispenser has an opening in its cover to permit the thumb of the user to be moved against the top flat object of a stack retained in the dispenser, so as to move the top of the object towards one end or the other of the dispenser to cause the object to be ejected. U.S. Pat. No. 3,286,823 provides in relevant part a business card dispenser comprising a dispenser case having a substantially like upper and lower boxed shaped cover portions disposed in opposed abutting relationship defining a rectangular chamber for releasably storing a stack of business cards. An opening is provided in the upper cover for to permit the user to frictionally engage the top business card stored within the case and sliding it out through a slot. Further, Des. 371, 723 is a design patent which depicts a design for a case storing and dispensing edible films. Moreover, U.S. Pat. No. 164,833 provides in relevant part a stamp holder box comprising two side pieces, two end pieces and four lids hinged transversely across the center of the box. The stamp holder may be configured for holding either two or four different kinds of stamps. When the holder is arranged for four kinds of stamps, there is a vertical partition dividing it into two compartments. The stamps are removed from the box by opening one or more the hinged lids.

Finally, U.S. Pat. No. 180,984 provides in relevant part a pocket case for cigarette papers or wrappers comprising a case, a top cover having a permanently-attached section and a hinged piece which forms a removable section of the top cover. Once the removable section of top cover is opened via a hook and catch mechanism, cigarette papers or wrappers stored within the case may then be removed. The cigarette papers are kept perfectly smooth and closely packed within the case by way of a spring and adjustable plate mechanism.

Notwithstanding the above, the prior art lacks decorative dispensers. More particularly, the prior art lacks dispensers which not only dispense orally dissolve film strips, such as candy strips but which are also decorated on their top cover with a character, animal or human face and have a flip top lid configured in the shape of a tongue so that the tongue shaped lid appears to be a tongue of the character, animal, etc.

### SUMMARY OF THE INVENTION

It is therefore a principle object of the invention to provide a dispenser for dispensing film strips (e.g. candy flavored film strips), which has a flip top lid configured in the shape of a tongue.

It is another object of the invention to provide a dispenser for dispensing film strips (e.g. candy flavored film strips), which has a flip top lid configured in the shape of a tongue to give the dispenser an overall decorative effect pleasing to children.

It is another object of the invention to provide a dispenser having a tongue shaped flip top lid and wherein the dispenser is also decorated with a character, person's, or animal's face thereon to further enhance the overall decorative effect of the dispenser.

It is another object of the present invention to provide a decorative dispenser for dispensing film strips which may also function as a toy for children due to its decorative appearance and its tongue shaped flip top lid.

It is a further object of the invention to provide a decorative dispenser for dispensing film strips (e.g. candy flavored film strips) which is small enough in size to fit in one's pocket.

In accordance with the present invention, a decorative dispenser for dispensing film strips is provided which includes a dispenser having a top surface. The top surface has an opening therein for allowing access to the film strips housed within the dispenser. The decorative dispenser further includes a flip top lid having one end pivotally attached to the top surface of the dispenser and an another end adapted to engage a front portion of said dispenser to sealing close the opening in said top surface of said dispenser, said flip top lid being configured to resemble a tongue to give the dispenser an overall decorative effect pleasing to children. In addition, a character, person's, or animal's face (e.g. image of eyes, nose and open mouth) is preferably affixed or placed onto the top surface of the dispenser above the tongue shaped flip top lid to give the appearance as if the tongue lid is part of the above-mentioned face to further enhance overall decorative effect of the dispenser.

### BRIEF DESCRIPTION OF THE DRAWINGS

FIG. 1 is a top perspective view of the dispenser when closed;

FIG. 2 is a perspective view of the bottom portion of the top cover of the dispenser;

FIG. 3 is a side perspective view of the dispenser with the flip top lid in the open position;

FIG. 4 is a perspective view of the front end of the dispenser;

FIG. 5 is a cross section taken substantially along line 5-5 of FIG. 1;

FIG. 6 is an cross-sectional fragmentary view of the rib member of the flip top lid engaged in locking position with the recess groove of a side wall of the dispenser;

FIG. 7 is a cross-sectional side view of the dispenser;

FIG. 8 is an enlarged cross-sectional fragmentary view of the rib member of the flip top lid engaged in locking position with the recess groove of a side wall of the dispenser

FIG. 9 is a cross-sectional side view of the top cover and bottom cover of the dispenser separated from one another;

FIG. 10 is a cross-sectional rear view of the top and bottom cover of the dispenser separated from one another;

FIG. 11 is a top perspective view of the dispenser with the flip top lid in the open position; and

FIGS. 12-16 represent various embodiments of the present invention with top perspective views of the top cover of the dispenser, each with a respectively different character design located thereon.

### DETAILED DESCRIPTION OF PREFERRED EMBODIMENTS

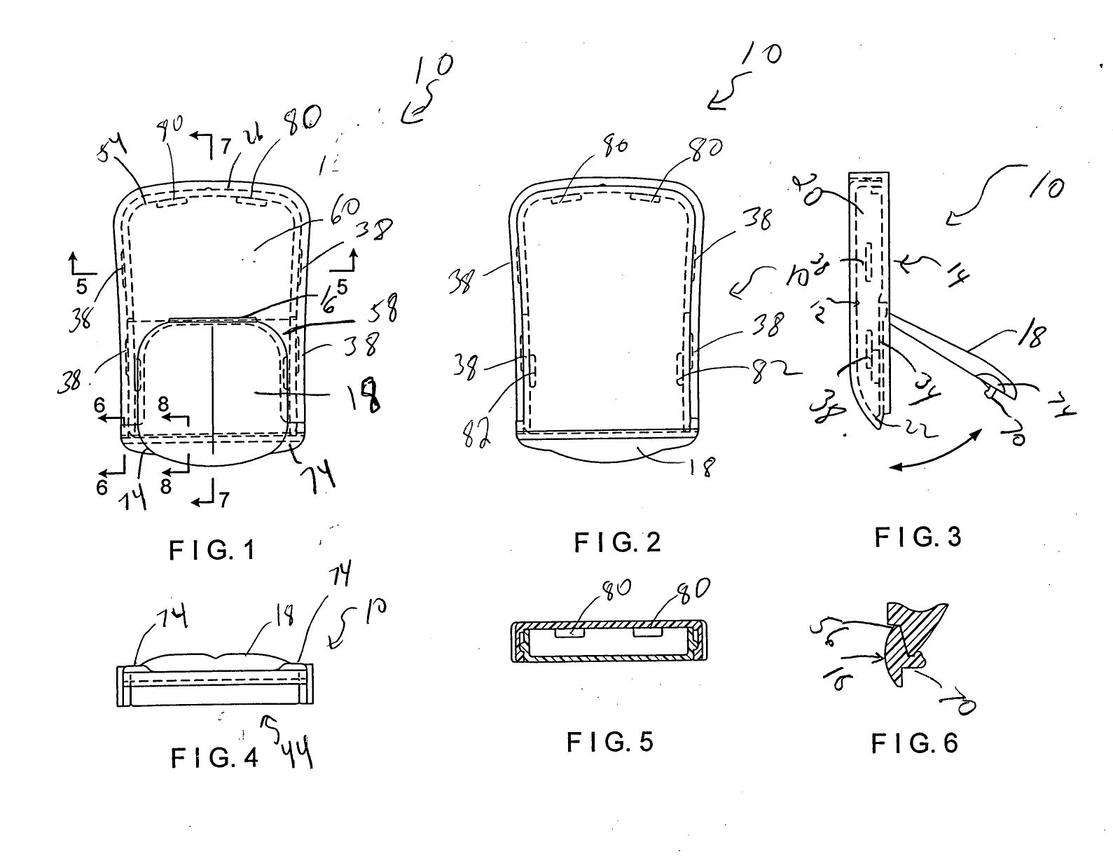

In practicing the present invention, any conventional flip top lid dispenser for dispensing thin objects such as thin film strips may be used, including a one piece non-detachable dispenser in which the top cover and bottom covers are integral with another. Most importantly, the critical aspects of the present invention relate to the decorative look and appearance of the dispenser. Namely, the dispenser of the present invention requires a flip top lid configured as a tongue of a character, animal, or person. It is also preferred that in addition to having tongue shaped lid, the tops of the dispensers should also be decorated with a character, animal or human face so that the tongue shaped lid appears to be a tongue of the character, animal, etc. Set forth below and illustrated in the drawings (FIGS. 1-16) is a preferred embodiment of the present invention and other variations of this embodiment are contemplated to be within the scope of the invention.

Now referring to a preferred embodiment of the present invention, depicted in FIGS. 1-16, a film strip dispenser is referred to generally at 10. The dispenser 10 is preferably made of plastic but is not limited thereto and may be made from other suitable materials such as aluminum, other metals, etc. Further, although the dispenser 10 is also not limited to any particular size in order to be within the spirit and scope of the invention, the dispenser 10 is preferably small enough to fit in ones pocket. The dispenser 10 itself includes a bottom cover 12 and a top cover 14 attached to one another, wherein a chamber or passageway 15 is defined within the bottom cover 12 of the dispenser 10. The dispenser 10 further includes a flexible hinge member 16 and a flip top lid 18.

Bottom cover 12 is configured in the form of a tray. Specifically, bottom cover 12 comprises a flat bottom 20. As shown in FIGS. 3, 7 and 9, flat bottom 20 is preferably rectangular, except for its front portion 22 which is curved upward from the plane of the flat bottom 20. It is noted however that the flat top is not limited to any particular geometric shape, other than to be configured to be the same shape or substantially the same shape as that of the top cover 14. As best illustrated in FIG. 11, the curved front portion 22 consists of an attachment lip 24 for assisting in the attachment of the bottom cover 12 to the top cover 14. Moreover, it is on the flat bottom 20 in which the film or candy strips are stacked for the user to remove them from the dispenser 10.

As shown in FIGS. 1 and 2, the bottom cover 12 further comprises an end wall 26, a first side wall 28 and a second side wall 30. End wall 26 extends perpendicular to the plane of the flat bottom 20 and is opposite to the front portion 22 of the bottom cover 12. Further, the end wall is disposed in between the first side wall 28 and second side wall 30 and integrally connected therewith. The first side wall 28 and the second side wall 30 extend perpendicular to the plane of the flat bottom 20 and each side wall 28, 30 spans practically the entire length of the bottom cover 12 from the end wall 26 up until a space 32 provided between the front portion 22 of the flat bottom 20 and the front of the side walls 28, 30. Additionally, as shown in FIGS. 3, 7 and 9, the front region 34 of the side walls 28, 30 is of slightly of lower height than the rear regions 36, which in turn creates a downward slope in the front region 34 of the side walls 28, 30. The downward sloping front regions 34 of the side walls 28, 30 coupled with the curved upward front portion 22 of the bottom provides the dispenser 10 with a shape which facilitates the removal of the film or candy strips from the bottom cover 12 by preventing the strips from becoming stuck within the dispenser 10. Lastly, as depicted in FIGS. 1-3 and 7-9, a plurality of spaced frictional members 38, 39, 40 and 41 on the exterior of the first side wall 28 and second side wall 30 for reducing the frictional engagement between top cover 14 and the bottom cover 12 when the dispenser 10 is fully assembled, thereby facilitating the sliding out the top cover 14 and bottom cover 12 from one another.

Next, as illustrated in FIGS. 1, 11-16, top cover 14 from which the film or candy strips are dispensed through comprises a flat top 42 having a front end 44, an upper surface 46 and a lower surface 48. As shown in FIGS. 1 and 12-16, flat top 42 is preferably of substantially rectangular shape, when the flip top lid 18 is in the closed position. However the flat top 42 is not limited to any particular geometrical shape, other than to be configured to be the same shape or substantially the same shape as that of the bottom cover 12. The top cover 14 further comprises an end member 50, a first side member 52 and a second side member 54. End member 50 extends perpendicular to the plane of the lower surface 48 of the flat top 42 and is opposite to the front end 44 of the top cover 14. Further, end member 50 is disposed in between the first side member 52 and second side member 54 and integrally connected therewith. The first side member 52 and the second side member 54 extend perpendicularly to the plane of the lower surface 48 of the flat top 42 and each side member 52, 54 on its front end has a recess groove 56 (FIG. 11) formed therein for assisting in retaining the flip top lid 18 in the closed position. Additionally, the front portions of the first side member 52 and the second side member 54 are designed to curve upward in order to correspond to the design of the side walls 28, 30 of the bottom cover 12 for providing a snug fit between the top cover 14 and the bottom cover 12 upon assembly of the dispenser 10.

The upper surface 46 of the flat top 42 of the top cover 14, as depicted in FIGS. 1 and 11-16, has a front portion 58 and a rear portion 60. As shown in FIGS. 3 and 11, the front portion 58 of the upper surface 46 of the flat top 42 has an opening 62 therein for allowing removal of the film strips stacked on the flat bottom 20 of the bottom cover 12. Meanwhile, flip top lid 18 is provided on the dispenser 10 to completely cover the opening 62 (see FIG. 1) in the front portion 58 of the top cover 14 when the lid 18 is in the closed position. The flip top lid 18, as best shown in FIG. 11, has a groove 64 in its middle portion to resemble a tongue and the lid 18 is pivotally connected to the dispenser 10 at the adjoining edges of the front portion 58 and rear portion 60 of the flat top 42 via a flexible hinge member 16. As shown in FIG. 1, when the tongue lid 18 is in the closed position, substantially the entire tongue lid 18 rests on the outer periphery flanges 65 which surround or border the opening 62, with the exception of the front portion 66 of the tongue lid 18 which protrudes slightly beyond the front of the top cover 14 of the dispenser 10. The tongue lid 18 is secured in the closed position via a lid locking mechanism.

Lid locking mechanism comprises a rib member 70, as shown in FIGS. 3, 6-8 and 11, extending horizontally across the bottom surface 72 of the tongue lid 18, a pair of snap elements 74 each located on opposing sides on the front end 66 of the tongue lid 18, and recess grooves 56 located on the ends of the side members 52, 54 which are adjacent to the front portion 44 of the top cover 14. The recess grooves 56 are adaptable for receiving the rib member 70 of the tongue flip top lid 18 for snapping the lid 18 into place to close the dispenser 10 when not in use. Snap elements 74 of the tongue lid 18 fit within the recess grooves 56 and these snap elements are locked or snapped into place by the rib member 70 which overlaps over and urges against the front of recess grooves 56, thereby snappingly securing the flip top lid 18 in the closed position.

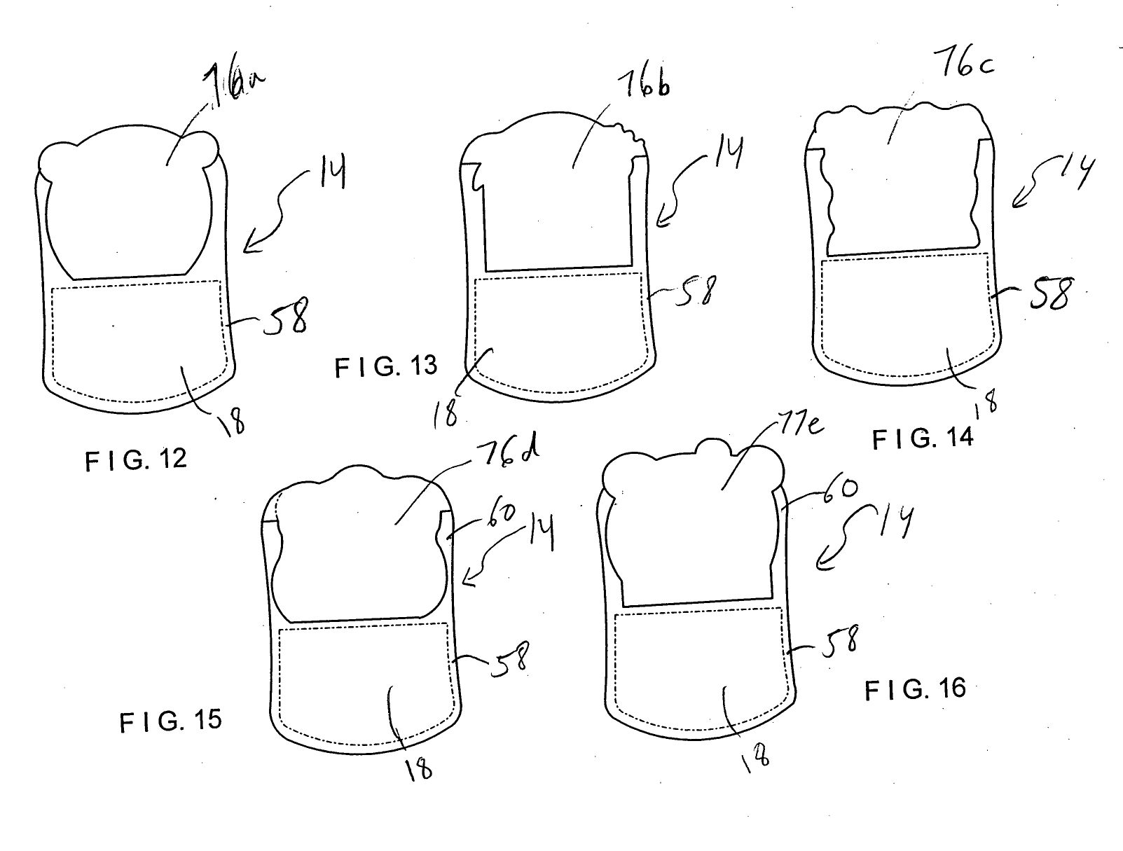

The rear portion 60 of the upper surface 46 of the flat top 42 of the top cover 14 is preferably configured to be decorated with a facial image. This image is preferably a character's, animal's or person's face. For example, FIGS. 12-16, illustrate various embodiments of the present invention each depicting different animal faces 76a, 76b, 76c, 76d, 76e. The above may be accomplished, for example by affixing such as by adhesively applying a sticker of a character's, animal's, or person's face onto the rear portion 60 of the flat top 42 or by painting the face thereon. The above methods simply serve as examples of decorating the dispenser 10 and in no way limit the scope of other possible methods or means to be used to accomplish that end. As can be seen in the drawings, the flip top lid tongue 18 appears to be part of the character's face located on the rear portion 60 of the flat top 42 of the top cover 14, giving the dispenser 10 an overall decorative effect which is pleasing to children and which makes the dispenser 10 fun for them to use.

The preferred embodiment of the dispenser of the present invention referred to FIGS. 1-16, is assembled by either sliding the top cover 14 over the bottom cover 12 or alternatively by sliding the bottom cover 12 upward and into the top cover 14, until the bottom cover 12 snaps into place underneath the top cover 14. As illustrated in FIGS. 1 and 2, the bottom cover 12 snaps into place underneath the top cover 14 via a snapping mechanism located on the lower surface 48 of the flat top 42 of the top cover 14. The snapping mechanism comprises a pair of end ribs 80 and a pair of side ribs 82 for locking or snapping the end wall 26 and side walls 28, 30 of the bottom cover 12, respectively, into place with the top cover 14. The end ribs 80 are located adjacent to one another on the lower surface 48 of the top cover 14 and define a gap between themselves and end member 50 for receiving and snapping or locking a portion of the end wall 26 of the bottom cover 12 there between. The side ribs 82 are located on the lower surface 48 of the top cover 14, opposite one another and define a gap between themselves and side members 52, 54 for receiving and snapping or locking a portion of the side walls 28, 30 of the bottom cover 12 there between.

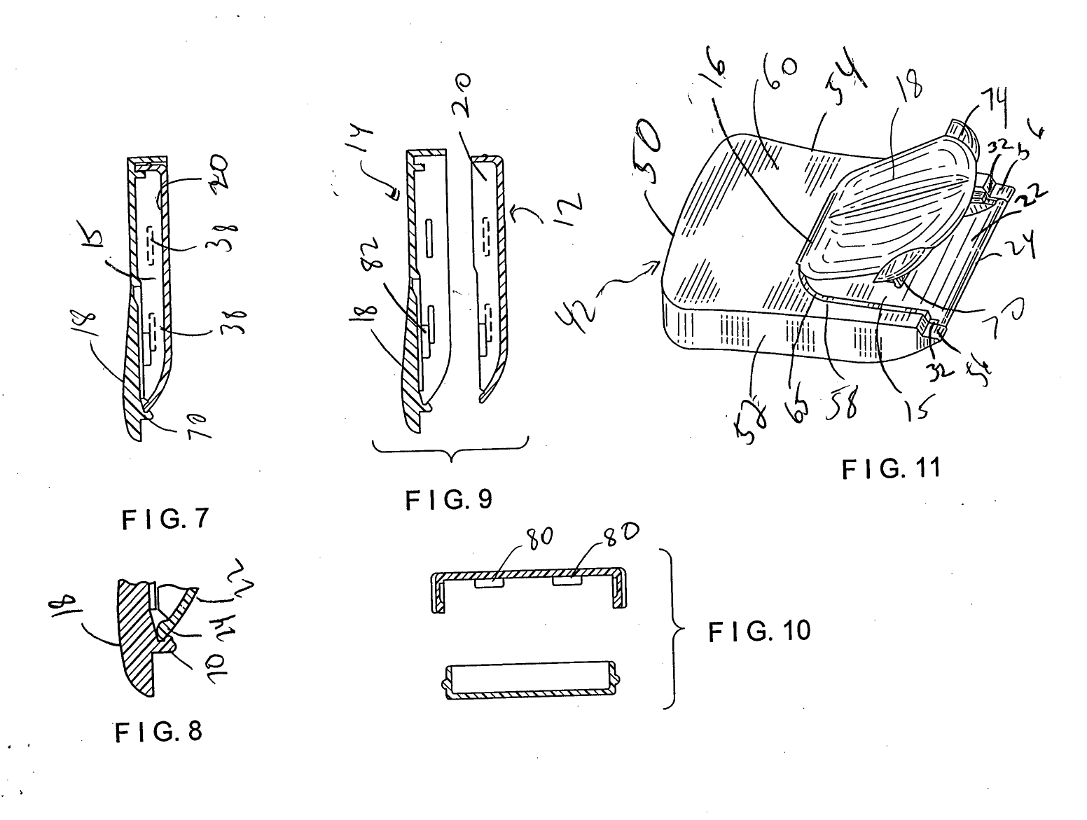

In addition to the snapping mechanism, the top cover 14 and bottom cover 12 are further secured together via the flip top tongue lid 18 (See FIG. 7). Namely, when the tongue lid 18 is in the closed position, the rib member 70 of the tongue lid 18 is snuggingly fit over and engaged with the attachment lip 24 of the bottom cover 12. The attachment to additionally secure the top cover 14 and bottom cover 12 together.

If desired, the dispenser 10 may disassembled easily by popping up the flip top lid 18 (see FIG. 1) and then by pushing down on the front portion 22 (see FIG. 1) of the flat top 42 to detach the bottom cover 12 from the top cover 14. Frictional members 38, 39, 40 and 41 (see FIGS. 1-3, 7 and 9) on the exterior of the first side wall 28 and second side wall 30 of the bottom cover 12 facilitate the above process of sliding out the top cover 14 and bottom cover 12 from one another.

In using the embodiment of the dispenser 10 of the present invention illustrated FIGS. 1-16, a person would first pop open the flip top lid 18 of the top cover 14 and reach through the opening 62 into chamber 15 of the dispenser 10 to remove one or more candy film strips, which are stacked on the flat bottom 20 of the bottom cover 12. Once the person is finished using the dispenser 10 they would then snap the lid 18 closed. Alternatively, if the user prefers they may also detach the bottom cover 12 from the top cover 14 and remove the candy strips directly from bottom cover 12 itself and then snap the top cover 14 and bottom cover 12 back together, as described above, when finished using the strips.

Children may also use this dispenser 10, not only to dispense candy film strips, but also as a fun toy due to its decorative nature. For instance, the top cover 14 of the dispenser 10 has the look of either a character, animal, or human, etc. with the flip top tongue shaped lid 18. Thus, a child can play with the tongue lid 18 by flipping it up and down to simulate the wagging of a character, animal, human, depending upon the type of face illustrated on the top cover.

The particular embodiments described above is not meant to be exclusive. Many other variations of the present invention would be obvious to those skilled in the art, and are contemplated to be within the scope of the appended claims.

1. A decorative dispenser for dispensing film strips comprising:
a dispenser having a top surface, said top surface having an opening therein for allowing access to said film strips housed within said dispenser; and
a flip top lid having one end pivotally attached to said top surface of said dispenser and an another end adapted to engage a front portion of said dispenser to sealing close the opening in said top surface of said dispenser, said flip top lid being configured to resemble a tongue.

2. The dispenser according to claim 1 wherein said tongue shaped flip top lid has a groove in the middle of said lid to a resemble a tongue.

3. The dispenser according to claim 1 wherein said dispenser is adapted to be decorated with a character, person or animal's face thereon so that said tongue shaped lid appears to be a tongue of said character, person or animal.

4. The dispenser according to claim 1, wherein said tongue has a bottom surface and said bottom of said tongue has a rib member engages the front portion of said dispenser so as to sealingly fasten said lid in a closed position to said dispenser.

5. The dispenser according to claim 1, wherein said film strips are orally dissolvable candy flavored film strips.

6. The dispenser according to claim 1, wherein said dispenser is made of plastic.

7. The dispenser according to claim 1, wherein said dispenser is a pocket size dispenser.

8. The dispenser according to claim 1, wherein said dispenser has a detachable bottom cover beneath said top surface.
